(19) United States
(12) Patent Application Publication
(10) Pub. No.: US 2006/0093829 A1
(43) Pub. Date: May 4, 2006

(54) Metal coated with a radiation curable outdoor durable coating

(76) Inventors: Donald R. Smith, Gibsonia, PA (US); Daniel Serafin, Baden, PA (US); Robert E. Bombalski, Pittsburgh, PA (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(21) Appl. No.: 11/152,421

(22) Filed: Jun. 14, 2005

Related U.S. Application Data
(60) Provisional application No. 60/623,498, filed on Oct. 29, 2004.
(60) Provisional application No. 60/623,689, filed on Oct. 29, 2004.
(60) Provisional application No. 60/623,499, filed on Oct. 29, 2004.
(60) Provisional application No. 60/623,688, filed on Oct. 29, 2004.

(51) Int. Cl. B32B 27/38; B32B 27/40; B32B 9/04

(52) U.S. Cl. 428/413; 428/423.1; 428/447

(57) ABSTRACT

This invention describes a metallic article coated with a radiation curable coating that exhibits resistance to weathering and UV exposure. The radiation curable coating is comprised of greater than about 95% solids by weight and is either clear or pigmented.

### CROSS REFERENCE TO RELATED APPLICATIONS

This application claims the benefit of U.S. Provisional Application Ser. Nos. 60/623,498, 60/623,689, 60/623,499, and 60/623,688 all of which were filed on Oct. 29, 2004 and are fully incorporated by reference herein.

### FIELD OF THE INVENTION

This invention generally relates to metals coated with liquid coating systems. Specifically, this invention relates to a coated metal having a greater than about 95% solids by weight radiation curable coating applied thereto.

### BACKGROUND OF THE INVENTION

The coating solvent used in traditional coating operations often contain volatile organic compounds (VOCs) that are evaporated from the solvent and released into the atmosphere as hazardous air pollutants (HAPs) during the process of drying or curing the coating onto the surface of an article. Additionally, a large quantity of hazardous waste is produced as a by-product of these coating operations. With growing environmental concerns and increasingly stricter government regulations, more emphasis has been placed on reducing or eliminating the amount of solvent used when coating aluminum and/or other metals.

In response to these growing concerns, several solutions have been implemented to control the environmental risks that are typically associated with traditional coating systems. One solution is to use pollution control equipment to capture VOC emissions in order to prevent them from becoming undesirable air pollutants. Another solution for reducing or eliminating VOC emissions is to use a coating system comprised of about 100% solids thereby eliminating the need for using pollution generating solvents. Typically, wet coatings comprising of about 100% solids require the use of radiation to cure the coating onto the metal substrate. These radiation curable coatings reduce the total costs associated with the manufacture of coated articles, when compared to solvent based coatings, because the articles do not have to be heated to an elevated temperature to cure the coating onto the surface of the underlying article. However, these systems historically lack the durability for outdoor use since many chalk, discolor, lose adhesion, or blister upon extended exposure to ultraviolet radiation and condensation.

Therefore, there exists a need for a metal article coated with a radiation curable coating that is able to withstand the rigors of outdoor use, yet still reduce the amount of VOC emissions released during its manufacture.

This invention is in response to those needs by disclosing a metal article having a greater than about 95% solids by weight radiation curable coating, as applied, which can withstand the rigors of outdoor use.

### SUMMARY OF THE INVENTION

This invention describes a metallic article coated with a radiation curable coating that exhibits resistance to weathering and UV exposure. The greater than about 95% solids by weight radiation curable liquid coating can either be clear or pigmented.

In one embodiment, the coating is cured to the metallic article by using either ultraviolet light or electron beam energy.

In one embodiment, the metallic article could be a cast, extruded, forged or rolled article.

In one embodiment, the metallic article can be fabricated from an aluminum alloy selected from the Aluminum Association's: 1XXX, 2XXX, 3XXX, 5XXX, 6XXX, 7XXX and 8XXX series of aluminum alloys.

In one embodiment, the aluminum alloy could be selected from the Aluminum Associations: 1XX.X, 2XX.X, 3XX.X, 4XX.X, 5XX.X, 7XX.X and 8XX.X series of aluminum alloys.

One aspect of this invention is to reduce or eliminate the solvent used in coating aluminum and other metals.

Another aspect of this invention is to provide a metal that is coated with a coating that can withstand weathering and UV exposure.

Another aspect of this invention is to reduce or eliminate the amount of volatile organic compound (VOC) emissions released when curing a coating onto an article by reducing or eliminating the amount of solvents that must be evaporated when the coating is cured.

Another aspect of this invention is to increase the processing speeds associated with the manufacture of a coated metal article.

### BRIEF DESCRIPTION OF THE DRAWINGS

FIG. 1 depicts an aluminum article that is coated with a pre-treatment coating and the radiation curable coating.

FIG. 2 depicts an aluminum article that is coated with only the radiation curable coating.

FIG. 3 depicts an aluminum article that is coated with a pre-treatment coating, a primer coating, and a radiation curable coating.

FIG. 4 depicts an aluminum article that is coated with a primer coating and a radiation curable coating.

### DETAILED DESCRIPTION OF PREFERRED EMBODIMENTS

The accompanying figures and the description that follows set forth this invention in its preferred embodiments. However, it is contemplated that persons generally familiar with coated metal articles will be able to apply the novel characteristics of the structures and methods illustrated and described herein in other contexts by modification of certain details. Accordingly, the figures and description are not to be taken as restrictive on the scope of this invention, but are to be understood as broad and general teachings. When referring to any numerical range of values, such ranges are understood to include each and every number and/or fraction between the stated range minimum and maximum. Finally, for purposes of the description hereinafter, the terms “upper”, “lower”, “right”, “left”, “vertical”, “horizontal”, “top”, “bottom”, and derivatives thereof shall relate to the invention as it is oriented in the drawing figures.

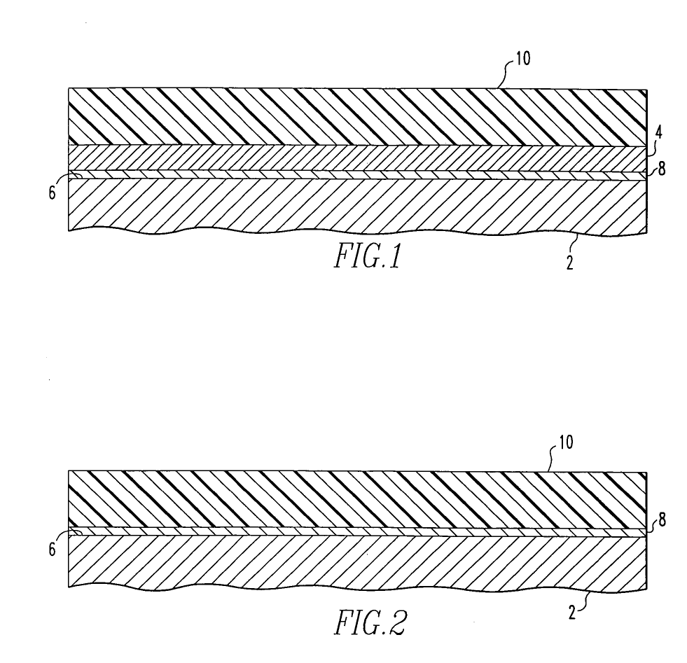

FIG. 1 depicts an aluminum article 2 coated with a pre-treatment coating 4, which can be chrome based or substantially chrome-free. The pre-treatment coating 4 is applied onto the surface 6 of the aluminum article 2 using coating techniques that are well known in the art at a coating weight ranging from about 0.05 grams per square meter (5 mg per square foot) to about 1.08 grams per square meter (100 mg per square foot). Preferably, the coating weight would range from about 0.05 grams per square meter (5 mg per square foot) to about 0.32 grams per square meter (30 mg per square foot). As can be understood from FIG. 1, the pre-treatment coating 4 is actually applied onto an oxide layer 8 that naturally forms on the surface 6 of the aluminum article 2 when the surface 6 is exposed to oxygen.

The pre-treatment coating 4 enhances the adhesion between the solid radiation curable coating 10, which is greater than about 95% solids by weight, as applied, and the surface 6 of the aluminum article 2. The radiation curable coating 10 can either be clear or pigmented. The thickness of the radiation curable coating 10 ranges from about 2.54 μm (0.0001 inches) to about 63.5 μm (0.0025 inches). Preferably the thickness of the radiation curable coating 10 ranges from about 12.7 μm (0.0005 inches) to about 38.1 μm (0.0015 inches). Typically, the pre-treatment coating 4 is a chromium based chemical conversion coating. However, due to increased health and environmental concerns the use of non-chromium based systems, such as titanium and zirconium coatings, have steadily increased. Another alternative is to pre-treat the surface 6 of the aluminum article 2 by using a phosphoric acid anodizing process that generates a thin, typically less than about 0.254 μm (0.00001 inches), porous oxide layer that promotes coating adhesion. In addition to increasing the adhesion of the radiation curable coating 10 to the surface 6 of the aluminum article 2 the pre-treatment coating 4 also provides some degree of corrosion protection to the surface 6 of the aluminum article 2 by insulating the surface 6 of the aluminum article 2 from the oxygen in the atmosphere.

FIG. 2 depicts the radiation curable coating 10 as being applied directly onto the naturally formed oxide layer 8 that is on the surface 6 of the aluminum article 2. Unlike FIG. 1, the aluminum article 2 in FIG. 2 is not coated with a pre-treatment coating 4. In FIG. 2, the radiation curable coating has a thickness ranging from about 2.54 μm (0.0001 inches) to about 63.5 μm (0.0025 inches) with a preferred thickness ranging from about 12.7 μm (0.0005 inches) to about 38.1 μm (0.0015 inches).

FIG. 3 depicts the radiation curable coating 10 as being applied directly onto a primer layer 12, which is applied over the pre-treatment coating 4. The primer layer 12 further enhances the adhesion between the radiation curable coating 10 and the aluminum article 2. As can be seen from FIG. 3, the pre-treatment coating 4 is applied over the naturally formed oxide layer 8 that is located on the surface 6 of the aluminum article 2. The thickness of the primer layer 12 ranges from about 2.54 μm (0.0001 in) to about 17.8 μm (0.0007 in). Preferably, the thickness of the primer layer 12 would range from about 5.1 μm (0.0002 in) to about 10.2 μm (0.0004 in). As depicted in FIG. 3, the primer layer 12 is applied directly onto the pre-treatment coating 4 prior to the application of the radiation curable coating 10.

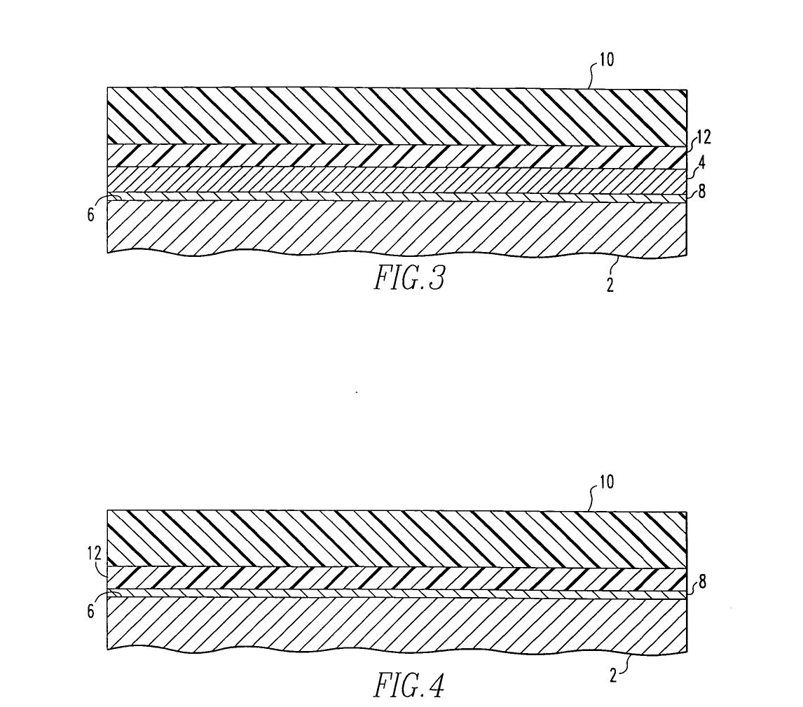

FIG. 4 depicts the radiation curable coating 10 as being applied directly onto a primer layer 12. Unlike FIG. 3, the primer layer 12 in this embodiment is applied directly onto the naturally formed oxide layer 8 on the surface 6 of the aluminum article 2. Similar to FIG. 3, the thickness of the primer layer 12 would range from about 2.54 μm (0.0001 inches) to about 17.78 μm (0.0007 inches) with a preferred thickness ranging from about 5.08 μm (0.0002 inches) to about 10.16 μm (0.0004 inches).

Prior to the application of the pre-treatment coating 4 (FIGS. 1 and 3), or the radiation curable coating 10 (FIG. 2), or the primer layer 12 (FIG. 4) onto the surface 6 of the aluminum article 2, the surface 6 can be cleaned using techniques that are well known in the art. For instance, an alkaline cleaner is often used to clean the surface 6 of an aluminum article 2 prior to the application of a coating.

The radiation curable coating 10 could be applied to the surface of many metallic articles. However, metallic articles that are exposed to the outdoor elements would benefit the most from the disclosed invention. For example, side panels used in truck, horse, and other trailers could be coated with the radiation curable coating 10 to enhance the panel's durability to outdoor exposure. Forged and cast vehicle wheels as well as extruded door and window frames would also benefit from having the radiation curable coating 10.

In one embodiment, the radiation curable coating 10 is comprised of a polyester, urethane, epoxy, acrylic, or a siloxane type resin. Typically the radiation curable coating 10 is composed of a variety of monomers and oligomers that are instantly polymerized when exposed to radiation such as ultraviolet light or electron beam energy. However, these forms of radiation are not meant to be limiting since one skilled in the art would recognize that other forms of radiation may be used to cure the radiation curable coating 10 onto the surface 6 of the aluminum article 2. The radiation curable coating 10 can be applied directly over the pre-treatment coating 4 (FIG. 1), the surface 6 of the aluminum article 2 (FIG. 2), or the primer coating 12 (FIGS. 3 and 4) using techniques that are well known in the art. For example, the radiation curable coating 10 could be applied over the aluminum article 2 using a spray, dipping, roll, slot, or curtain coating method.

Spray coating typically involves the use of a spray gun to coat the aluminum article 2 by atomizing the radiation curable coating 10 before depositing/spraying the radiation curable coating 10 onto the aluminum article 2 with the spray gun. Nozzle selection, fan width of the spray, and volume of the radiation curable coating 10 that is to be deposited are all factors that must be considered when using this technique. Once the radiation curable coating 10 has been deposited over the aluminum article 2, the radiation curable coating 10 is cured onto the aluminum article 2 by exposing the radiation curable coating 10 to a form of radiation.

The dip coating method involves immersing the aluminum article 2 into a liquid bath of the radiation curable coating 10. The aluminum article 2 is then removed from the bath to allow the excess radiation curable coating 10 to drip back into the liquid bath. After the excess radiation curable coating 10 has been removed, the aluminum article 2 is exposed to a form of radiation in order to cure the radiation curable coating 10 onto the aluminum article 2.

Roll coating involves transferring the radiation curable coating 10 from a revolving applicator roll to the aluminum article 2 as the aluminum article 2 passes adjacent to the revolving applicator roll. Once the radiation curable coating 10 has been applied onto the aluminum article 2, the radiation curable coating 10 is cured onto the aluminum article 2 by exposing the radiation curable coating 10 to a form of radiation.

Slot coating typically involves applying the radiation curable coating 10 to the aluminum article 2 by forcing the radiation curable coating 10 through a slot die and applying the coating 10 directly onto the aluminum article 2 as the article 2 passes adjacent to an aperture of the slot die. The aluminum article 2 is typically located on a roller that is adjacent to the aperture of the slot die thereby allowing for the continuous coating of the aluminum article 2. The flow rate of the radiation curable coating 10 through the slot die and the line speed are variables that must be considered when utilizing the slot coating technique.

Curtain coating involves passing the aluminum article 2 through a sheet (i.e. curtain) of falling radiation curable coating 10 that is being pushed or gravity fed through a slot or slide type die. The amount of radiation curable coating 10 leaving the die and the speed at which the aluminum article 2 is passed through the falling sheet of coating determines the thickness of the radiation curable coating that is applied onto the aluminum article 2. As with the other application techniques, the radiation curable coating 10 is cured onto the surface 6 of the aluminum article 2 by exposing the radiation curable coating 10 to a form a radiation.

In one embodiment, the radiation curable coating 10 would meet or exceed the ASTM D3359-02 standard for coating adhesion, the ASTM G53-96 and SAE J2020 standards for UV and humidity stability, and the ASTM B117-03 standard for salt spray performance. Additionally, the radiation curable coating 10 would meet or exceed the ASTM D3794-00 standard for formability, the ASTM D2794-93(2004) standard for impact resistance, and have a minimum tensile hardness of (H) under the ASTM D3363-05 standard. It is noted, however, that other embodiments of the radiation curable coating 10 could meet or exceed one or more of the preceding standards.

Even though FIGS. 1-4 depict an aluminum article 2 as the metal that is being costed other metals or metal alloys (e.g. steel or a steel alloy) can be used without departing from the teachings of this invention.

TABLE 1

| | | | ASTM G53-96 |
|---|---|---|---|
| Trial | Pre-treatment | Alloy | 1000 Hours |
| 1 | N/A | 5XXX | Slight Chalking |
| (control) | | series | after 1000 |
| | | | hours |
| 2 | Clean Only | 5XXX | Pass |
| | | series | |
| 3 | Chromate | 5XXX | Pass |
| | Conversion | series | |
| | Coating | | |
| 4 | Chrome-free | 5XXX | Pass |
| | Conversion | series | |
| | Coating | | |

In Table 1, the durability of the solid radiation curable coating that is disclosed in this invention was compared to a solvent based coating that is currently used in the industry. In each of the trials, a 5XXX series Aluminum Association alloy was used as the underlying substrate. The durability of the coating on the surface of the aluminum substrate was tested by exposing each aluminum substrate to 1000 hours of cyclic ultraviolet radiation and condensation, using an Atlas UVCON ultraviolet/condensation screening device per ASTM G53-96. After being exposed to 1000 hours of radiation/condensation, the coating on the aluminum substrate was visually inspected to determine whether the ultraviolet radiation/condensation had degraded the coating. A coating that had been degraded by the ultraviolet radiation/condensation would exhibit a dull appearance or discoloration since the radiation would have broken down the organic components of the coating. For clarity, the dull appearance hereafter will be referred to as chalking.

In trial #1, the aluminum substrate was cleaned using a standard alkaline cleaner, pre-treated with a chromium based chemical solution, and coated with an acrylic solvent based coating using a traditional reverse roll coating process. The coating was applied onto the surface of the aluminum substrate at a thickness of about 17.8 μm (0.0007 inches) and thermally cured at a peak metal temperature of about 240.5° C. (465° F.). As can be understood from Table 1, the aluminum alloy in trial #1 exhibited slight chalking after being exposed to about 1000 hours of ultraviolet radiation/condensation as per ASTM G53-96.

In trial #2, the aluminum substrate was cleaned using a standard alkaline cleaner, and coated with a 100% solids radiation curable coating having a thickness of about 17.8 μm (0.0007 inches). The coating was applied onto the aluminum substrate using a wire-wound drawbar and cured using ultraviolet radiation. As can be seen from table 1, the radiation curable coating in this trial was given a rating of “pass” since the coating exhibited no chalking or discoloration after being exposed to about 1000 hours of ultraviolet radiation/condensation per ASTM G53-96.

Trial #3 involved cleaning the aluminum substrate using a standard alkaline cleaner and pre-treating the substrate with a chromium based chemical solution. After the pre-treatment step, the aluminum substrate was coated with the same radiation curable coating that was used in trial #2. The thickness of the radiation curable coating was about 17.8 μm (0.0007 inches). Similar to trial #2, the radiation curable coating was applied onto the surface of the aluminum substrate using a wire-wound drawbar and cured using ultraviolet radiation. After being exposed to about 1000 hours of ultraviolet radiation/condensation, the radiation curable coating in trial #3 did not exhibit any chalking or discoloration. Therefore, the radiation curable coating in trial #3 was given a rating of “pass.”

The aluminum substrate in trial #4 was cleaned using a standard alkaline cleaner, pre-treated with a chromium-free chemical solution, and coated with the same radiation curable coating that was used in trials 2 and 3 using a wire-wound drawbar. The thickness of the radiation curable coating was about 17.8 μm (0.0007 inches). Similar to trials 2 and 3, the radiation curable coating in trial #4 was given a rating of “pass” since the coating did not exhibit any chalking or discoloration after being exposed to about 1000 hours of ultraviolet radiation/condensation.

TABLE 2

| | | | SAE J2020 |
|---|---|---|---|
| Trial | Pre-treatment | Alloy | 2500 Hours |
| 5 | N/A | 5XXX | Moderate |
| (control) | | | Chalking at |
| | | | 720 Hours |
| 6 | Clean Only | 5XXX | Slight |
| | | | Chalking at |
| | | | 1,104 hours |
| 7 | Chromate | 5XXX | Slight |
| | Conversion | | Chalking at |
| | Coating | | 1,104 hours |
| 8 | Chrome-free | 5XXX | Slight |
| | Conversion | | Chalking at |
| | Coating | | 1,104 hours |

Table 2, similar to Table 1, compares the durability of the radiation curable coating that is disclosed in this invention with an industry standard solvent based coating. The underlying substrate that was used in trials 5-8 was a 5XXX series Aluminum Association alloy. Unlike trials 1-4, however, trials 5-8 involved exposing the 5XXX series aluminum substrates to about 2500 hours of ultraviolet radiation and condensation per SAE J2020 using an Atlas UVCON ultraviolet/condensation screening device. The SAE J2020 standard exposes the aluminum substrates to a more severe testing environment than the ASTM G53-96 standard (i.e. SAE J2020 uses a higher energy UV lamp and higher temperatures per cycle). Therefore, in trials 5-8 the radiation curable coating was expected to chalk at an earlier time than in trials 1-4. In trials 5-8, the aluminum substrates were visually inspected at pre-determined time intervals to determine whether the substrates exhibited any chalking or discoloration.

In trial #5, the aluminum substrate was cleaned using a standard alkaline cleaner, pre-treated with a chromium based chemical solution, and coated with the acrylic solvent based coating used in trial #1. The coating was applied onto the substrate using a traditional reverse roll coating process at a thickness of about 17.8 μm (0.0007 inches) and thermally cured at a peak metal temperature of about 240.5° C. (465° F.). As can be seen in Table 2, the aluminum substrate in trial #5 exhibited moderate chalking after being exposed to ultraviolet radiation/condensation for about 720 hours. Again, earlier chalking is expected since the SAE J2020 standard exposes the substrate to a more hostile testing environment.

Trial #6 involved applying the same radiation curable coating that was used in trials 2-4 to a 5XXX series aluminum substrate. Similar to trial #5, the aluminum substrate was cleaned using a standard alkaline cleaner, and coated with a 100% solids radiation curable coating at thickness of about 17.8 μm (0.0007 inches). The coating was applied onto the aluminum substrate using a wire-wound drawbar and cured using ultraviolet radiation. As can be understood from Table 2, the radiation curable coating began to exhibit slight chalking after being exposed to ultraviolet radiation/condensation for about 1,104 hours as per SAE J2020.

Trial #7 involved cleaning the aluminum substrate using a standard alkaline cleaner, pre-treating the substrate with a chromium based chemical solution, and coating the aluminum substrate with the same radiation curable coating used in trial #6. The thickness of the coating was about 17.8 μm (0.0007 inches), which was applied onto the aluminum substrate using a wire-wound drawbar and cured using ultraviolet radiation. After being exposed to about 1,104 hours of ultraviolet radiation/condensation, the radiation curable coating in trial #7 began to exhibit slight chalking.

Trial #8 involved cleaning the 5XXX series aluminum substrate using a standard alkaline cleaner, pre-treating the substrate with a chromium-free chemical solution, and coating the substrate with the same radiation curable coating used in trial #7 at thickness of about 17.8 μm (0.0007 inches). As with the previous trials, the coating was applied onto the aluminum substrate using a wire-wound drawbar and cured using ultraviolet radiation. The solid radiation curable coating in trial #8, similar to trials 6 and 7, began to exhibit slight chalking after being exposed to ultraviolet radiation/condensation for about 1,104 hours.

In trials 1 and 5, the aluminum substrate was coated with an acrylic solvent based coating that is currently being used in the industry. Conventional solvent and water based coatings, such as the coating used in trials 1 and 5, are thermally cured and consequently affect the rate at which a coated metal product may be produced since the line speed (i.e. processing speed) is ultimately limited by the necessity to heat the metal substrate up to the coating's curing temperature. Typically, the heavier the metal gauge, the slower the product needs to be run in order to allow the metal enough time to reach the coating's cure temperature. With radiation curable coatings, however, no heating of the metal is required since the coatings are cured almost instantaneously by the radiation. Accordingly, by using a radiation curable coating processing speed is no longer limited by the metal gauge.

Having described the presently preferred embodiments it is to be understood that the invention may be otherwise embodied within the scope of the appended claims.

What is claimed is:

1. A metallic article coated with a radiation curable liquid coating comprising:
a clear or pigmented radiation curable coating that exhibits resistance to weathering and UV exposure, said coating comprising greater than about 95% solids by weight; and
said coating being applied over said metallic article.

2. A metallic article according to claim 1 wherein said metallic article is manufactured from an aluminum alloy.

3. A metallic article according to claim 2 wherein said aluminum alloy is selected from a group consisting of the 1XXX, 2XXX, 3XXX, 5XXX, 6XXX, 7XXX, and 8XXX series of aluminum alloys.

4. A metallic article according to claim 2 wherein said aluminum alloy is selected from a group consisting of the 1XX.X, 2XX.X, 3XX.X, 4XX.X, 5XX.X, 7XX.X, and 8XX.X series of aluminum alloys.

5. A metallic article according to claim 2 wherein said aluminum alloy is cleaned.

6. A metallic article according to claim 1 wherein said metallic article is pretreated with a chrome or chrome-free conversion coating or pretreated by phosphoric acid anodizing to form an oxide layer, said conversion coating or said oxide layer being adjacent to a surface of said metallic article.

7. A metallic article according to claim 6 wherein said coating is adjacent to said conversion coating or said oxide layer.

8. A metallic article according to claim 6 wherein a primer layer is adjacent to said conversion coating or said oxide layer, and said coating is adjacent to said primer layer.

9. A metallic article according to claim 1 wherein said coating is adjacent to a surface of said metallic article.

10. A metallic article according to claim 1 wherein said primer layer is adjacent to a surface of said metallic article, and said coating is adjacent to said primer layer.

11. A metallic article according to claim 1 wherein said coating is applied by a spray, roll, slot, curtain, or dipping method.

12. A metallic article according to claim 1 wherein said coating has a thickness from about 2.54 μm (0.0001 inches) to about 63.5 μm (0.0025 inches).

13. A metallic article according to claim 1 wherein said coating is cured using ultraviolet light or electron beam energy.

14. A metallic article according to claim 1 wherein said metallic article is cast, extruded, forged, or rolled.

15. A metallic article according to claim 1 wherein said radiation curable coating comprises a polyester, urethane, epoxy, acrylic or siloxane type resin.

16. A metallic article according to claim 1 where said metallic article is a cast vehicle wheel, an extruded floor, an extruded window frame, a forged vehicle wheel, or a rolled sheet.

17. A metallic article according to claim 16 wherein said rolled sheet is a trailer panel used in truck, horse, and auto trailers.

18. A method of making a metallic article coated with a radiation curable liquid coating that exhibits resistance to weathering and UV exposure comprising:
providing a metallic article;
coating said metallic article with a clear or pigmented radiation curable coating comprising greater than about 95% solids by weight; and
curing said coating with radiation selected from ultraviolet light, or electron beam energy.

19. A method of making a metallic article according to claim 18 wherein coating said metal with said radiation curable coating by a spray, roll, slot, curtain, or dipping method.

20. A method of making a metallic article according to claim 18 wherein coating said metal with said radiation curable coating until said radiation curable coating has a thickness from about 2.54 μm (0.0001 inches) to about 63.5 μm (0.0025 inches).

21. A method of making a metallic article according to claim 18 wherein providing a metallic article that is manufactured from an aluminum alloy.

22. A method of making a metallic article according to claim 21 wherein providing an aluminum article manufactured from the group consisting of the 1XXX, 2XXX, 3XXX, 5XXX, 6XXX, 7XXX, and 8XXX series of aluminum alloys.

23. A method of making a metallic article according to claim 21 wherein providing an aluminum article manufactured from the group consisting of the 1XX.X, 2XX.X, 3XX.X, 4XX.X, 5XX.X, 7XX.X, and 8XX.X series of aluminum alloys.

24. A method of making a metallic article according to claim 21 wherein cleaning said aluminum alloy article prior to coating said metallic article with said radiation curable coating.

25. A method of making a metallic article according to claim 18 wherein pretreating said metallic article with a chrome or chrome-free conversion coating or pretreating said cleaned alloy by phosphoric acid anodizing to form an oxide layer, said conversion coating or said oxide layer being adjacent to a surface of said metallic article.

26. A method of making a metallic article according to claim 25 wherein applying said coating onto said conversion coating or said oxide layer.

27. A method of making a metallic article according to claim 25 wherein applying a primer layer onto said conversion coating or said oxide layer, said coating being applied onto said primer layer.

28. A method of making a metallic article according to claim 18 wherein applying a primer layer onto a surface of said metallic article, said coating being applied onto said primer layer.

29. A method of making a metallic article according to claim 18 wherein applying said coating onto a surface of said metallic article.

30. A method of making a metallic article according to claim 18 wherein coating said metallic article with a radiation curable coating comprising a polyester, urethane, epoxy, acrylic or siloxane type resin.

31. A method of making a metallic article according to claim 18 wherein providing a metallic article that is a cast vehicle wheel, an extruded floor, an extruded window frame, a forged vehicle wheel, or a rolled sheet.

32. A method of making a metallic article according to claim 31 wherein providing a rolled sheet that is used as a trailer panel in truck, horse, or auto trailers.
